(19) United States
(12) Patent Application Publication
(10) Pub. No.: US 2010/0172382 A1
(43) Pub. Date: Jul. 8, 2010

(54) APPARATUS AND METHOD FOR GENERATING FREQUENCY-VARIABLE SIGNAL

(75) Inventors: Kwan Il LEE, Seoul (KR); Sang Bae Lee, Seoul (KR); Sun Duck KIM, Jeollabuk-do (KR)

Correspondence Address: BACON & THOMAS, PLLC, 625 SLATERS LANE, FOURTH FLOOR, ALEXANDRIA, VA, 22314-1176, US

(73) Assignee: KOREA INSTITUTE OF SCIENCE AND TECHNOLOGY, Seoul (KR)

(21) Appl. No.: 12/547,712

(22) Filed: Aug. 26, 2009

(30) Foreign Application Priority Data
Jan. 5, 2009 (KR) 10-2009-0000295

(51) Int. Cl. H01S 3/10; H01S 3/083; G02B 26/00

(52) U.S. Cl. 372/20; 385/1

(57) ABSTRACT

An apparatus for generating a frequency-variable signal includes a light source; first and second resonators, to which the optical signals from the light source are input; a structure optically connected to the first resonator so as to be deformable by strain; a first and a second optical fiber gratings located on the structure to filter optical signals of a first wavelength and a second wavelength, respectively; and a photoelectric converter optically connected to the first resonator to generate a signal of a frequency corresponding to an interval between the first wavelength and the second wavelength. The interval between the first wavelength and the second wavelength corresponds to a degree of deformation of the structure.

### FIELD OF THE INVENTION

The present invention relates to an apparatus for generating a frequency-variable signal and a method for generating a frequency-variable signal.

### BACKGROUND OF THE INVENTION

In recent years, a microwave signal based on optical technology is widely used in a wireless local loop, a phase array antenna, an ROF (Radio Over Fiber) system, and the like, and is attracting public attention. This technology is advantageous in that, since light is used, there is no interference due to electromagnetic waves. Also the bandwidth is large, and an optical fiber with low loss can be used. Microwave generation based on the optical technology is obtained by beating two optical signals having different wavelengths and photoelectrically converting a high-frequency with phase noise.

In the related art, microwave signal generation based on an optical wave is obtained by beating two phase-locked laser beams in order to reduce phase noise or by using an external modulator. In this case, however, a high-purity reference high-frequency signal source is needed. In another method without reference high-frequency signal source, microwave is generated by using a two-wavelength, single longitudinal mode optical fiber laser.

Korean Patent Publication No. 10-2007-0097671, which is assigned to the same applicant as the present application, entitled “MICROWAVE SIGNAL GENERATOR USING AN OPTICAL FIBER LASER SOURCE BASED ON AN ULTRA-NARROW BAND PASS FILTER TO BE OPERATED IN A SINGLE LONGITUDINAL MODE” discloses a scheme that operates an optical fiber laser in a single longitudinal mode to causes oscillation by using an ultra-narrow band pass filter, thereby beating light sources with two wavelengths. The above-described methods according to the related art have a problem in that microwave frequency conversion is difficult.

### SUMMARY OF THE INVENTION

In view of the above, the present invention provides an apparatus and method of generating a frequency-variable signal that implements a two-wavelength light source with a variable interval between oscillation wavelengths depending on the strain, and beats two-wavelength optical signals so as to generate a signal of a frequency corresponding to an interval between the oscillation wavelengths.

According to the apparatus and method of generating a frequency-variable signal of the present invention, one or more optical fiber gratings are located on the structure that is deformable by strain. The interval between oscillation wavelengths of two-wavelength optical signals can be controlled by deformation of the structure. As a result, the frequency of a beating signal generated from the two-wavelength optical signals can be effectively changed.

According to the apparatus and method of generating a frequency-variable signal of the present invention, a microwave signal can be generated by using an optical fiber laser. For this reason, there is no interference due to an electromagnetic wave, and an optical fiber with low loss can be used. As a result, the apparatus and method of generating a frequency-variable signal of the embodiments can be useful for optical communication and an ROF (Radio Over Fiber) system.

### BRIEF DESCRIPTION OF THE DRAWINGS

The above and other features of the present invention will become apparent from the following description of an embodiment given in conjunction with the accompanying drawings, in which:

FIG. 1 is a schematic view of an apparatus for generating a frequency-variable signal in accordance with an embodiment of the present invention;

FIG. 2A is a perspective view of a structure in the apparatus for generating a frequency-variable signal shown in FIG. 1;

FIG. 2B is a plan view of the structure shown in FIG. 2A;

FIG. 3A is a graph illustrating the wavelengths of a two-wavelength optical signal in the apparatus for generating a frequency-variable signal shown in FIG. 1;

FIG. 3B is a graph illustrating the wavelength of a signal that is generated by a photoelectric converter in the apparatus for generating a frequency-variable signal shown in FIG. 1;

FIG. 4 is a schematic view of an apparatus for generating a frequency-variable signal in accordance with another embodiment of the present invention;

FIG. 5A is a graph illustrating a transmission spectrum of a first optical fiber grating and a reflection spectrum of a second optical fiber grating in the apparatus for generating a frequency-variable signal shown in FIG. 4; and

FIG. 5B is a graph illustrating the wavelengths of a two-wavelength optical signal in the apparatus for generating a frequency-variable signal shown in FIG. 4.

### DETAILED DESCRIPTION OF THE EMBODIMENTS

Hereinafter, the present invention will be described in detail with reference to the accompanying drawings. In the following description, detailed descriptions of known functions or configurations incorporated herein that are well known to those skilled in the art will be omitted for clarity and conciseness.

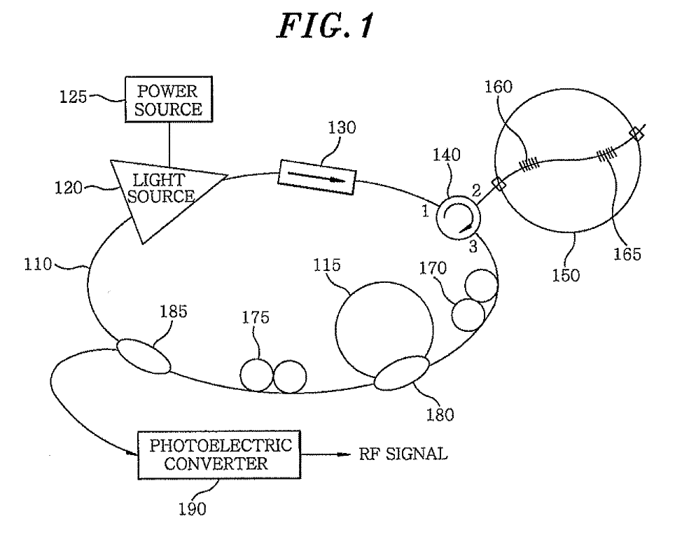

FIG. 1 is a schematic view showing the configuration of an apparatus for generating a frequency-variable signal in accordance with an embodiment of the present invention.

Referring to FIG. 1, an apparatus for generating a frequency-variable signal includes a light source 120, first and second resonators 110 and 115, a deformable structure 150, first and second optical fiber gratings 160 and 165, and a photoelectric converter 190.

The light source 120 is supplied with power from a power source 125 and generates amplified optical signals. For example, the light source 120 may include a semiconductor optical amplifier (SOA). When a semiconductor optical amplifier is used in the light source 120, multi-wavelength optical signals can oscillate simultaneously due to inhomogeneous broadening of the semiconductor optical amplifier. The optical signals generated by the light source 120 are input to the first resonator 110.

The optical signals of the light source 120 oscillate in the first resonator 110. The first resonator 110 is optically connected to the second resonator 115. For example, the second resonator 115 is connected to the first resonator 110 through a first optical coupler 180. The first optical coupler 180 may be a 50:50 coupler. The optical signals of the light source 120 oscillate only at a frequency satisfying both the resonance conditions of the first and second resonators 110 and 115. Therefore, a single mode optical signal can be obtained. For example, the optical signals may be signals that oscillate in a single longitudinal mode due to the Vernier effect.

The apparatus for generating a frequency-variable signal further includes an optical isolator 130 optically connected to the first resonator 110. The optical isolator 130 suppresses backward progress of light due to reflection, thereby improving oscillation efficiency.

The structure 150 is optically connected to the first resonator 110 through an optical circulator 140. The optical circulator 140 has a plurality of ports, such that an optical signal input to each port can be transmitted to an adjacent port. For example, when the optical circulator 140 has three ports, an optical signal may be transmitted in an order of a first port, a second port, and a third port. In this case, the first port and the third port of the optical circulator 140 are optically connected to the first resonator 110, and the second port of the optical circulator 140 is optically connected to the structure 150.

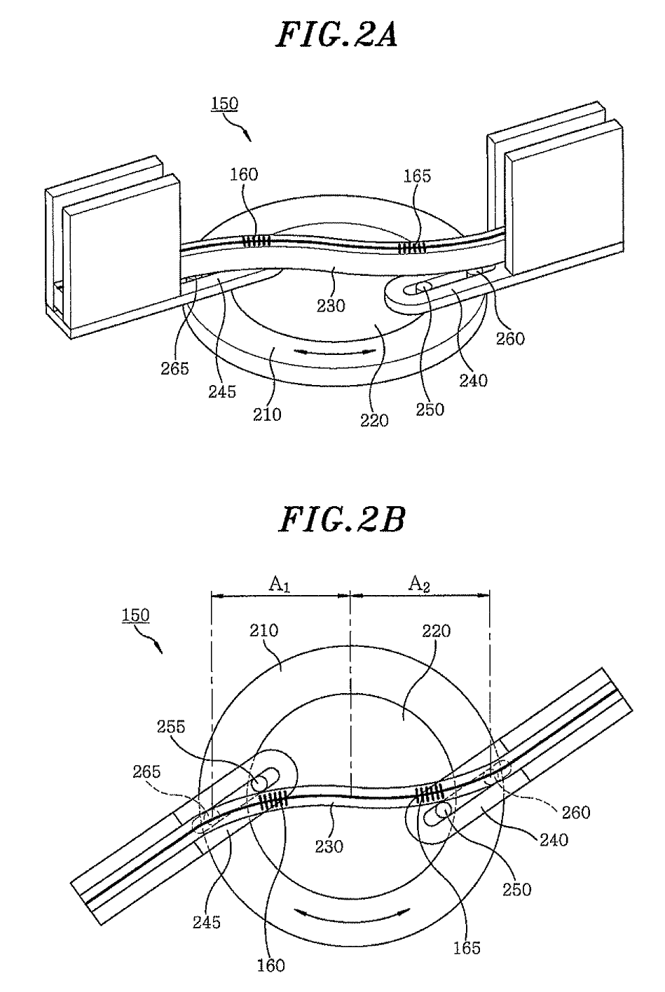

The structure 150 receives the optical signals through the optical circulator 140. The structure 150 is deformable by strain. For example, the structure 150 includes a thin metal plate that is deformable by strain. The configurations and functions of the structure 150 will be described below in detail with reference to FIG. 2.

The first and second optical fiber gratings 160 and 165 are located on the structure 150. The first and second optical fiber gratings 160 and 165 filter optical signals of specific wavelengths from among the transmitted optical signals. For example, the first and the second optical fiber gratings 160 and 165 may be reflective optical fiber gratings reflecting optical signals of a first wavelength and a second wavelength, respectively.

If the optical signals are input from the optical circulator 140 to the structure 150, the optical signals of the first wavelength and the second wavelength are reflected by the first and the second optical fiber gratings 160 and 165, respectively. The reflected optical signals are transmitted to the second port of the optical circulator 140. The optical signals, having reached the second port of the optical circulator 140, are input to the first resonator 110 again through the third port of the optical circulator 140.

The first and second resonators 110 and 115 further include polarization controllers 170 and 175 optically connected thereto, respectively. The polarization controllers 170 and 175 control the polarization of the optical signals in the resonators 110 and 115, thereby obtaining an optical signal oscillating in a stable single mode.

The photoelectric converter 190 is optically connected to the first resonator 110 through a second optical coupler 185. The second optical coupler 185 transmits some of the optical signals in the first resonator 110 to the photoelectric converter 190. For example, the second optical coupler 185 extracts some optical signals from the first resonator 110 and transmits the extracted optical signals to the photoelectric converter 190 while circulating the other optical signals in the first resonator 110.

The photoelectric converter 190 beats the input optical signals so as to generate an electrical signal. The photoelectric converter 190 generates a signal of a frequency corresponding to a beating frequency of the optical signal of the first wavelength and the optical signal of the second wavelength. For example, the photoelectric converter 190 generates a microwave signal. The photoelectric converter 190 may include a photodetector (not shown). In this case, the bandwidth of the photodetector is larger than the frequency range of a microwave signal desired to obtain.

The electric fields of two optical signals input to the photoelectric converter 190 are expressed by Equation 1.

Eₖ(t)=aₖ(t)e^{i(ω}_{ₖ}^{t+φ}_{ₖ}^{(t))} [Equation 1]

For Equation 1, ak (where k=1, 2) denotes the intensity of each of the optical signal of the first wavelength and the optical signal of the second wavelength. ωk and φk denote the frequency and the phase of a corresponding optical signal, respectively.

A superimposed signal of two optical signals input to the photoelectric converter 190 is expressed by Equation 2.

Eₜₒₜ(t)=E₁(t)+E₂(t)=a₁(t)e^{i(ω}_{₁}^{t+φ}_{₁}^{(t))}+a₂(t)e^{i(ω}_{₂}^{t+φ}_{₂}^{(t))} [Equation 2]

A current in the photoelectric converter 190 is proportional to the intensity of incident light. Therefore, the current is proportional to the square of a total electric field, as expressed by Equation 3.

I∝|Eₜₒₜ(t)|²=a₁²+a₂²+2a₁a₂ cos(Δωt+Δφ) [Equation 3]

For Equation 3, Δφ denotes a phase difference between two optical signals, and Δω denotes a different in frequency between two optical signals.

That is, the frequency of an electrical signal to be generated by beating two optical signals becomes equal to the difference in frequency of the two optical signals.

In the apparatus for generating a frequency-variable signal having the above-described configuration, the frequency of a signal (for example, a microwave signal) that is generated by the photoelectric converter 190 can be controlled in accordance with a degree of deformation of the structure 150. For example, when strains in different directions are applied to the first and second optical fiber gratings 160 and 165 on the structure 150, the reflected wavelengths of the two optical fiber gratings 160 and 165 may be moved in different directions. For this reason, an interval between oscillation wavelengths of two-wavelength optical signals may be changed, and as a result, the frequency of a signal to be generated from the two-wavelength optical signal may be changed.

FIG. 2A is a perspective view showing the structure in the apparatus for generating a frequency-variable signal shown in FIG. 1. FIG. 2B is a plan view of the structure shown in FIG. 2A.

Referring to FIGS. 2A and 2B, the structure 150 includes a first disc 210, a second disc 220, and a flat plate 230. The first disc 210 has a hollow shape. The first disc 210 is formed so as to be rotatable. The second disc 220 is located inside the first disc 210. The first and second discs 210 and 220 may be formed of a metal or an appropriate material.

First and second supports 240 and 245 are located around the boundary between the first and second discs 210 and 220. Each of the first and second supports 240 and 245 has formed therein a groove. The first support 240 is fixed to the second disc 220 by a screw 250 located at the groove. The first support 240 is also fixed to the first disc 210 by a screw 260. Similarly, the second support 245 is fixed to the second disc 220 by a screw 255 located at the groove. The second support 245 is also fixed to the first disc 210 by a screw 265.

The flat plate 230 is fixed between the first and second supports 240 and 245. If the first disc 210 rotates, the screws 260 and 265 located at the first disc 210 are rotated together with the first disc 210. Meanwhile, the screws 250 and 255 located at the second disc 220 are not moved. Therefore, the angles of the first and second supports 240 and 245 are changed. As a result, the flat plate 230, which is fixed between the first and second supports 240 and 245, is deformed. For example, as shown in FIGS. 2A and 2B, the flat plate 230 is deformed in the shape of alphabet letter “S”. The flat plate 230 is formed of a material that is deformable by strain. For example, the flat plate 230 may be a relatively thin metal plate.

Referring to FIG. 2B, the deformed flat plate 230 has a first area A1 that is deformed in a first direction and a second area A2 that is deformed in a second direction, different from the first direction. For example, the first direction and the second direction are opposite directions. The first and the second optical fiber gratings 160 and 165 are located in the first area A1 and the second area A2 of the flat plate 230, respectively.

The direction of strain to be applied to the first optical fiber grating 160 located in the first area A1 and the direction of strain to be applied to the second optical fiber grating 165 located in the second area A2 are opposite each other. For example, when the reflected wavelength of the first optical fiber grating 160 increases due to strain, the reflected wavelength of the second optical fiber grating 165 decreases. As a result, the interval between the reflected wavelengths of the first and second optical fiber gratings 160 and 165 is changed by strain applied to the flat plate 230.

Strain to be applied to each of the areas A1 and A2 flat plate 230 may be changed depending on the rotation angle of the first disc 210. Therefore, by changing the rotation angle of the first disc 210, the interval between the reflected wavelengths of the first optical fiber grating 160 and the second optical fiber grating 165 can be changed. The apparatus for generating a frequency-variable signal may further include an angle controller (not shown) connected to the first disc 210 that controls the rotation angle of the first disc 210.

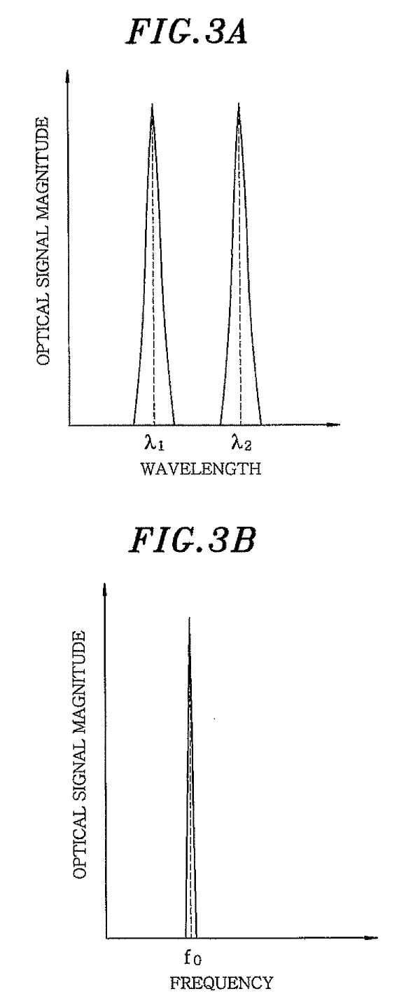

FIG. 3A is a graph illustrating the wavelengths of a two-wavelength optical signal in the apparatus for generating a frequency-variable signal shown in FIG. 1. Referring to FIG. 3A, the two-wavelength optical signal filtered by the first and second optical fiber gratings is an optical signal having a first wavelength λ1 and a second wavelength λ2.

FIG. 3B is a graph illustrating the wavelength of a signal generated by the photoelectric converter in the apparatus for generating a frequency-variable signal shown in FIG. 1. Referring to FIG. 3B, a signal generated by the photoelectric converter has a frequency f0 corresponding to an interval between the first wavelength and the second wavelength.

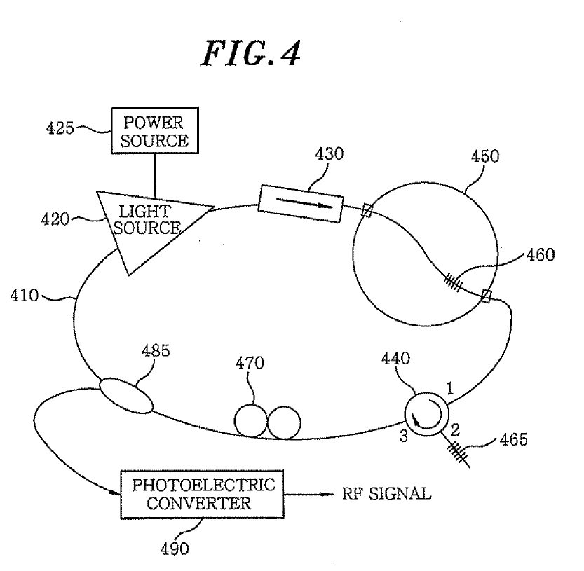

FIG. 4 is a schematic view showing the configuration of an apparatus for generating a frequency-variable signal in accordance with another embodiment of the present invention.

Referring to FIG. 4, the apparatus for generating a frequency-variable signal includes a light source 420, a resonator 410, a deformable structure 450, first and second optical fiber gratings 460 and 465, and a photoelectric converter 490. In FIG. 4, the light source 420, a power source 425, an optical isolator 430, a polarization controller 470, an optical coupler 485, and a photoelectric converter 490 have the same configuration and function as the constituent elements of the apparatus for generating a frequency-variable signal described with reference to FIG. 1, respectively, and thus detailed descriptions thereof will be omitted.

The optical signals of the light source 120 are input to the resonator 410. The optical signals oscillate in the resonator 410. The structure 450 is optically connected to the resonator 410. The structure 450 is deformable by strain applied thereto. The structure 450 has the same configuration and function as the structure 150 described with reference to FIGS. 1 and 2, and thus a detailed description thereof will be omitted.

The first optical fiber grating 460 is located on the structure 450. The first optical fiber grating 460 has relatively low transmittance at a predetermined center wavelength, and has relatively high transmittance at a first wavelength and a second wavelength around the center wavelength. For example, the first optical fiber grating 460 may be a phase-shifted optical fiber grating having a very narrow band transmission width at the first wavelength and the second wavelength. When the structure 450 is deformed, strain is applied to the first optical fiber grating 460 located on the structure 450, and the interval between the first wavelength and the second wavelength is changed.

The second optical fiber grating 465 is connected to the resonator 410 through the optical circulator 440. For example, the first port and the third port of the optical circulator 440 are optically connected to the resonator 410, and the second port of the optical circulator 440 is optically connected to the second optical fiber grating 465. The optical signals having transmitted the first optical fiber grating 460 are input to the first port of the optical circulator 440. The input optical signals are transmitted to the second optical fiber grating 465 through the second port of the optical circulator 440. The optical signals having transmitted the first optical fiber grating 460 are reflected by the second optical fiber grating 465, such that only the optical signals of the first wavelength and the second wavelength can be filtered. To this end, the second optical fiber grating 465 may be a reflective optical fiber grating. The second optical fiber grating 465 has the same center wavelength as that of the first optical fiber grating 460.

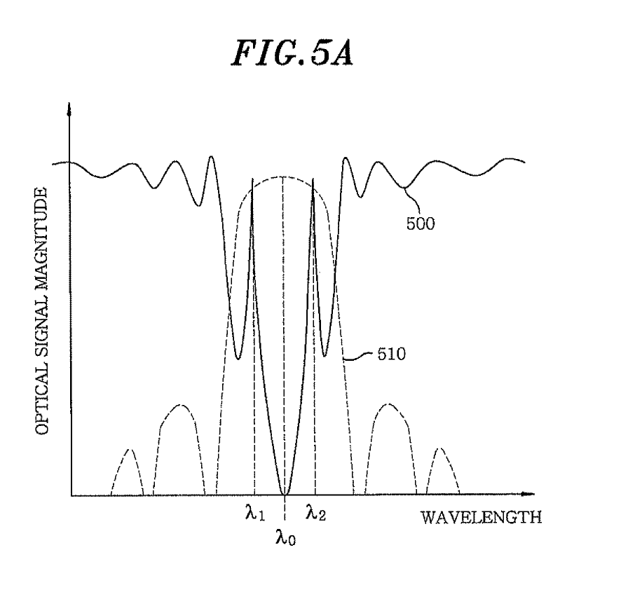

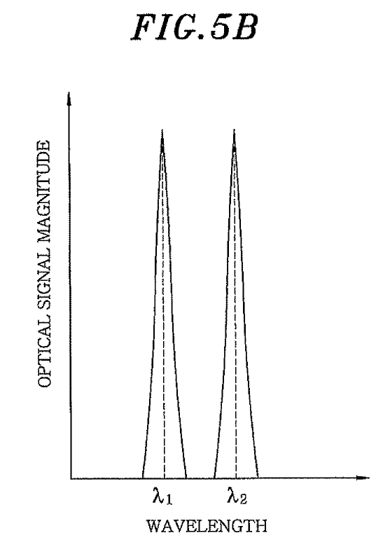

FIG. 5A is a graph showing a transmission spectrum of the first optical fiber grating and a reflection spectrum of the second optical fiber grating in the apparatus for generating a frequency-variable signal shown in FIG. 4. In FIG. 5A, a solid line 500 represents the transmission spectrum of the first optical fiber grating, and a dotted line 510 represents the reflection spectrum of the second optical fiber grating.

As shown in FIG. 5A, the first optical fiber grating has relatively low transmittance at a predetermined center wavelength λ0, and has relatively high transmittance at the first wavelength λ1 and the second wavelength λ2 located symmetrically with respect to the center wavelength λ0. The first optical fiber grating transmits optical signals of a predetermined wavelength band including the first wavelength λ1 and the second wavelength λ2.

The second optical fiber grating has relatively high reflectance at the predetermined center wavelength λ0. The center wavelengths of the first optical fiber grating and the second optical fiber grating may be identical or close to each other. Therefore, when the optical signals having transmitted the first optical fiber grating are input to the second optical fiber grating, optical signals of wavelengths at which the first optical fiber grating has high transmittance and the second optical fiber grating has high reflectance can be filtered. For example, optical signals of the first wavelength λ1 and the second wavelength λ2 are filtered.

FIG. 5B is a graph illustrating the wavelength of an optical signal filtered by the first optical fiber grating and the second optical fiber grating. As shown in FIG. 5B, the filtered optical signal has the first wavelength λ1 and the second wavelength λ2. Therefore, a two-wavelength optical signal can be generated by using the first optical fiber grating and the second optical fiber grating.

With the apparatus for generating a frequency-variable signal and the method of generating a frequency-variable signal using the foregoing embodiments, the interval between oscillation wavelengths of two-wavelength optical signals can be changed by strain to be applied to the optical fiber gratings when the structure is deformed. As a result, a signal having a frequency corresponding to the interval between oscillation wavelengths can be changed in frequency.

While the invention has been shown and described with respect to the embodiment, the technical scope of the invention is not limited by the accompanying drawings and detailed descriptions. It will be understood by those skilled in the art that various changes and modifications may be made without departing from the scope of the invention as defined in the following claims.

What is claimed is:

1. An apparatus for generating a frequency-variable signal, the apparatus comprising:
a light source generating optical signals;
first and second resonators, to which the optical signals from the light source are input, wherein the first and second resonators have different resonance conditions;
a structure optically connected to the first resonator so as to be deformable by strain;
a first optical fiber grating and a second optical fiber grating located on the structure to filter optical signals of a first wavelength and a second wavelength, respectively; and
a photoelectric converter optically connected to the first resonator to generate a signal of a frequency corresponding to an interval between the first wavelength and the second wavelength,
wherein the interval between the first wavelength and the second wavelength corresponds to a degree of deformation of the structure.

2. The apparatus of claim 1, wherein the structure has a first area configured to be deformed in a first direction and a second area configured to be deformed in a second direction, and
the first optical fiber grating and the second optical fiber grating are located in the first area and the second area, respectively.

3. The apparatus of claim 2, wherein the structure includes a first hollow disc, a second disc inside the first disc, and a flat plate connected to the first disc and the second disc so as to be deformed by rotation of the first disc, and
wherein the first area and the second area are located on the flat plate.

4. The apparatus of claim 1, wherein the first optical fiber grating and the second optical fiber grating are reflective optical fiber gratings.

5. The apparatus of claim 1, further comprising:
an optical circulator optically connected between the first resonator and the structure,
wherein the optical circulator has a first port optically connected to the first resonator, a second port optically connected to the structure, and a third port optically connected to the first resonator.

6. The apparatus of claim 1, further comprising:
polarization controllers optically connected to the first resonator and the second resonator, respectively.

7. The apparatus of claim 1, wherein the light source includes a semiconductor optical amplifier.

8. The apparatus of claim 1, wherein the first resonator and the second resonator are ring resonators.

9. The apparatus of claim 1, further comprising:
an optical isolator optically connected to the first resonator.

10. An apparatus for generating a frequency-variable signal, the apparatus comprising:
a light source generating optical signals;
a resonator, to which the optical signals from the light source are input;
a structure optically connected to the resonator so as to be deformable by strain;
a first optical fiber grating located on the structure to transmit optical signals of a wavelength band including a first wavelength and a second wavelength;
a second optical fiber grating optically connected to the resonator to filter optical signals of the first wavelength and the second wavelength from the optical signals having transmitted the first optical fiber grating; and
a photoelectric converter optically connected to the resonator to generate a signal of a frequency corresponding to an interval between the first wavelength and the second wavelength,
wherein the interval between the first wavelength and the second wavelength corresponds to a degree of deformation of the structure.

11. The apparatus of claim 10, wherein the structure has a first area configured to be deformed in a first direction and a second area configured to be deformed in a second direction, and
wherein the first optical fiber grating is located in one of the first area or the second area.

12. The apparatus of claim 11, wherein the structure includes a first hollow disc, a second disc inside the first disc, and a flat plate connected to the first disc and the second disc so as to be deformed by rotation of the first disc, and
wherein the first area and the second area are located on the flat plate.

13. The apparatus of claim 10, wherein the first optical fiber grating is a phase-shifted optical fiber grating,
the second optical fiber grating is a reflective optical fiber grating, and
the first optical fiber grating and the second optical fiber grating have the same center wavelength.

14. The apparatus of claim 10, further comprising:
an optical circulator optically connected between the resonator and the second optical fiber grating,
wherein the optical circulator has a first port optically connected to the resonator, a second port optically connected to the second optical fiber grating, and a third port optically connected to the resonator.

15. The apparatus of claim 10, further comprising:
a polarization controller optically connected to the resonator.

16. The apparatus of claim 10, wherein the light source includes a semiconductor optical amplifier.

17. The apparatus of claim 10, wherein the resonator is a ring resonator.

18. The apparatus of claim 10, further comprising:
an optical isolator optically connected to the resonator.

19. A method of generating a frequency-variable signal, the method comprising:
generating optical signals;
filtering optical signals of a first wavelength and a second wavelength from among the optical signals by using a first optical fiber grating and a second optical fiber grating;
adjusting an interval between the first wavelength and the second wavelength by using strain to be applied to the first optical fiber grating and the second optical fiber grating; and
generating a signal of a frequency corresponding to the interval between the first wavelength and the second wavelength.

20. A method of generating a frequency-variable signal, the method comprising:
generating optical signals;
transmitting optical signals of a wavelength band including a first wavelength and a second wavelength, among the optical signals, by using a first optical fiber grating;
filtering optical signals of the first wavelength and the second wavelength from the optical signals having transmitted the first optical fiber grating by using a second optical fiber grating;
adjusting an interval between the first wavelength and the second wavelength by using strain to be applied to the first optical fiber grating; and
generating a signal of a frequency corresponding to the interval between the first wavelength and the second wavelength.
